(19) United States
(12) Patent Application Publication
(10) Pub. No.: US 2009/0125812 A1
(43) Pub. Date: May 14, 2009

(54) SYSTEM AND METHOD FOR AN EXTENSIBLE MEDIA PLAYER

(75) Inventors: Tomi BLINNIKKA, San Pablo, CA (US); Ashot PETROSIAN, San Francisco, CA (US); Maya DOBUZHSKAYA, San Francisco, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/355,661

(22) Filed: Jan. 16, 2009

Related U.S. Application Data
(63) Continuation-in-part of application No. 12/185,040, filed on Aug. 1, 2008.
Application No. 12/185,040 is a continuation-in-part of application No. 12/165,290, filed on Jun. 30, 2008.
Application No. 12/165,290 is a continuation-in-part of application No. 11/874,171, filed on Oct. 17, 2007.

(51) Int. Cl. G06F 3/00

(52) U.S. Cl. 715/716

(57) ABSTRACT

In a method and system for creating an extensible media player, a multimedia player application is instantiated on a client system. A timeline to be played by the instantiated multimedia player application is transmitted to the client system. One or more modules and one or more layouts are dynamically selected and retrieved for the timeline. The modules contain application logic to extend a functionality of the multimedia player application. The layouts contain logic to control an aspect of a presentation of the multimedia player application and the modules. The timeline, the modules, and the layouts are loaded into the multimedia player application. The loaded modules are verified to determine if any module is blocking the timeline from playing. If a module is blocking the timeline from playing, the blocking module is executed and playback of the timeline is stopped until execution is complete. If no module is blocking the timeline, the timeline begins playing back. Each subsequent module and each loaded layout is executed at a predetermined time during playback of the timeline. As each module is executed, the module is checked to determine whether the module is blocking the timeline from playing. If the module is blocking the timeline, playback of the timeline is stopped or paused until execution of the module is complete.

### CROSS-REFERENCE TO RELATED APPLICATIONS

The present application is a continuation-in-part of application Ser. No. 12/185,040, filed Aug. 1, 2008, entitled, “System and Method for Implementing an Ad Management System for an Extensible Media Player”, which is a continuation-in-part of application Ser. No. 12/165,290, filed Jun. 30, 2008, entitled, “Extensions for System and Method for an Extensible Media Player”, which is a continuation-in-part of application Ser. No. 11/874,171, filed Oct. 17, 2007, entitled, “System and Method for an Extensible Media Player”. The present application incorporates these earlier-filed applications by reference.

### BACKGROUND

1. Field of the Invention

Aspects of the present invention relate generally to a media player, and more particularly, to an extensible media player.

2. Description of Related Art

Current media player solutions found on Internet web pages are designed and written like most computer applications. When a new feature is to be added to the media player, the feature must be written into the main media player application, essentially requiring a full product cycle. This increases the deployment time of the media player.

Current media player solutions also fail to provide a fully dynamic system to program the user experience on-the-fly. While solutions exist to render different visual items based on cue points within the media being played or based on pre-defined criteria, these items are fixed and must be pre-programmed with the media being played.

Thus, it would be desirable to provide a method and system for creating an extensible media player capable of being modified dynamically to provide a highly interactive experience for a user.

### SUMMARY

Embodiments of the present invention overcome the above-mentioned and various other shortcomings of conventional technology, providing a method and system for creating an extensible media player.

In accordance with one aspect, a media player application may be instantiated on a client system. A timeline to be played by the instantiated media player application may be transmitted to the client system. One or more modules and one or more layouts are dynamically selected and retrieved for the timeline. The modules may contain application logic to extend a functionality of the multimedia player application. The layouts may control an aspect of a presentation of the multimedia player application and the modules. The timeline, the modules, and the layouts may be loaded into the media player application. One of the loaded modules may identify and retrieve one or more multimedia files to be played or one or more applications to be executed by the media player application. The loaded modules are verified to determine if any module is blocking the timeline from initiating playback. If a module is blocking the timeline from playing, the blocking module may be executed and playback of the timeline may be prevented from starting until execution is complete. If no module is blocking the timeline, the timeline may begin playback. Each subsequent module and loaded layout are executed at predetermined times during playback of the timeline. As each module executes, the module may be checked to determine if the module is a blocking module. If the module is a blocking module, playback of the timeline may be stopped or paused, and the module may execute. Once the module has finished executing, playback of the timeline may resume until the timeline reaches its end.

The foregoing and other aspects of various embodiments of the present invention will be apparent through examination of the following detailed description thereof in conjunction with the accompanying drawing figures.

### BRIEF DESCRIPTION OF THE DRAWING FIGURES

FIG. 1 is a simplified diagram illustrating an embodiment of a system for providing an extensible media player.

FIG. 2 illustrates an embodiment of an extensible media player system.

FIG. 3 illustrates an embodiment of an extensible media player application.

FIG. 4 illustrates an embodiment of an extensible media player application.

FIG. 5 illustrates an embodiment of an extensible media player application.

FIG. 6 illustrates an embodiment of an extensible media player application.

FIG. 7 is a flowchart illustrating one embodiment of a method for providing an extensible media player.

FIG. 8 illustrates an embodiment of a software platform supporting an extensible media player.

FIG. 9A illustrates an embodiment of a blocking scenario.

FIG. 9B illustrates an embodiment involving the use of a blocking module.

FIG. 9C illustrates an embodiment involving the use of a blocking module.

FIG. 9D illustrates an embodiment involving multiple blocking modules.

FIG. 10A illustrates an embodiment of a layout container.

FIG. 10B illustrates an embodiment of a layout container.

FIG. 10C illustrates an embodiment of a layout container.

FIG. 11 illustrates an embodiment of a layout container.

FIG. 12 illustrates an embodiment of a time source.

FIG. 13 is a flowchart illustrating one embodiment of a method for providing an extensible media player

### DETAILED DESCRIPTION

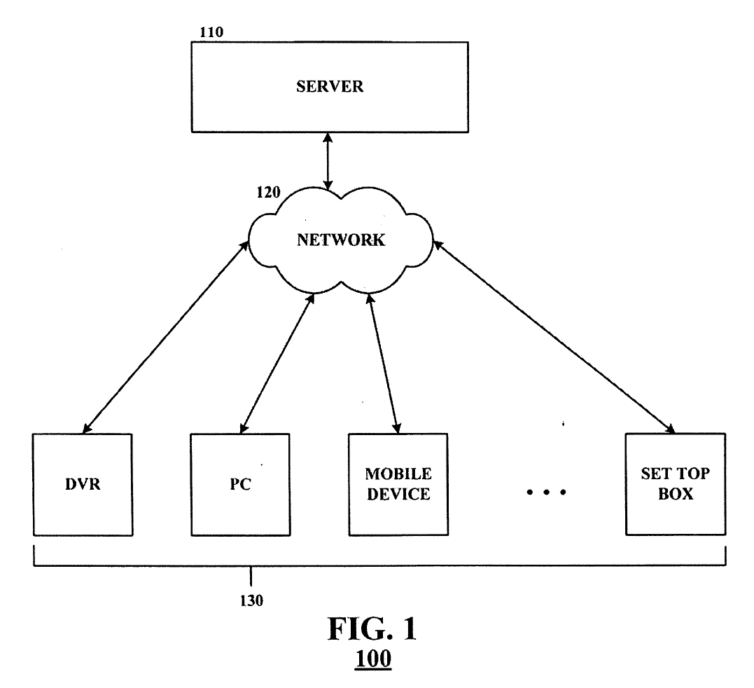

FIG. 1 is a simplified diagram illustrating one embodiment of a system for providing an extensible media player. The system 100 includes one or more servers storing a plurality of media files. The media files may be encoded in any format, including but not limited to the mpeg, avi, wmv, wma, mov, wav, mp3, aau, m4a, m4p, MIDI, and DivX formats. Various other encoding formats may be used advantageously with the embodiments described herein below; differences between these formats are immaterial to the present discussion unless otherwise noted. The servers also may store a player application, which may be passed to a plurality of client devices, and a plurality of modules, each of which may extend a functionality aspect or presentation aspect of the player application. Each module may include visual items, application logic, or a combination of the two. The servers may create and store a presentation data file based on user requests and third party requests, such as requests from content providers and advertisers. The presentation data file also may be created editorially. The presentation data file may be a XML-based file, such as, for example, a Media RSS (MRSS) file with extensions for the player application. The presentation data file may define the media items available to be played by the player application, as well as the player application components (i.e., modules) to be displayed for each media item. The presentation data file also may specify when each module associated with each media item becomes active and inactive, as well as the location of each module in the media player application. The presentation data file may be transmitted to any of the plurality of client devices.

The system also may include a plurality of client devices capable of instantiating or executing a media player application to play a media file, such as a video file or an audio file. The devices may include but are not limited to personal computers, digital video recorders (DVRs) or personal video recorders (PVRs), set top boxes which may receive content through cable, satellite, or Internet Protocol via network infrastructure including but not limited to wireless media and fiber optic cable (e.g., IPTV or Internet television), and mobile devices, such as cell phones, personal digital assistants (PDAs), or other wireless devices capable of playing video files. Each device may include software to process and play media files. The software may comprise a standalone media player capable of playing media files and parsing the presentation data file to execute modules. Alternatively, the software may include an Internet browser or other software in which the media player application, in the form of, for example, a Java applet or Flash-based player, may be instantiated or embedded. A client device may be configured to send a request through a network to the server to access one of the media files presented in the presentation data file. In response to a request from a connected device, a server may stream or transfer the selected media file(s) and accompanying modules associated with the selected media file over a network to the requesting device.

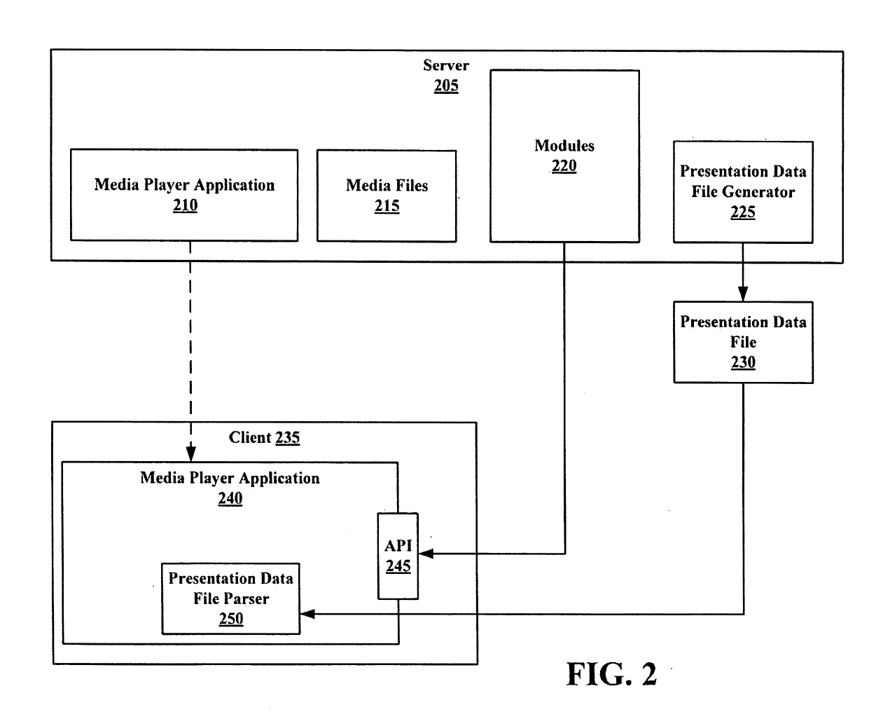

FIG. 2 illustrates an embodiment of a system for providing an extensible media player. The system may include a server 205 connected, in one embodiment, through a wired or wireless network, to a client device 235, such as a personal computer or portable communications device (e.g., a wireless telephone or Personal Digital Assistant (PDA)). The server 205 may store a media player application 210 or software code for implementing or instantiating a media player application on the client device 235, one or more media files 215, and one or more modules 220. The server 205 also may store presentation data files or include a presentation data file generator 225 which generates presentation data files.

The media files 215 may have any video or audio or mixed video/audio format, including but not limited to the types mentioned earlier. The particular format of the media files 215 stored in the server 205 is immaterial for the purposes of the present discussion, unless otherwise noted. The media files need not be stored in only one server, and may be stored in multiple servers. The one or more modules may provide additional player functionality or presentation features for the media player application. Examples of modules may include but are not limited to a player controls module, a playlist module to display available media files, a pre-timeline curtain module to display an advertisement prior to a media file, a banner to display a presentation aspect during playing of a media file, a post-roll curtain to display a presentation aspect subsequent to the playing of a media file, and a container to display third party content. Generally, modules may be designed and stored to interface with the media player application prior to, during, or subsequent to the playback of a media file. The modules may control an aspect of the playback of media files or may affect an aspect of the presentation of the media player application to a user.

The modules related to presentation aspects of the media player application may either transparently overlay or fully obscure part or all of the media file being played. Each module may have a default aspect ratio of 4:3, but may have logic necessary to conform to other aspect ratios, such as 16:9. Each module also may be resizable to any size. The modules may be configured to retrieve additional data from remote sources, such as the server, if needed, or to record and transmit usage information to the remote source. For example, if a closed captioning module is associated with a media file, the closed captioning module may retrieve the closed captioning data from a remote source to present to a user. The modules 220 also may be interactive, thereby enabling the user to control presentation of the media file or to access additional related content presented to the user before, during, or after presentation of the media file. In one embodiment, the media player application 240 and the modules 220 may be Flash-based components conforming to a specific version of Flash, including but not limited to, Flash 9. The container module may enable non-Flash third party content or third party content not conforming to a specific version of Flash to be displayed in conjunction with the media file being played in the media player application.

The presentation data files, either stored in the server 205 or generated by the presentation data file generator 225, may define a set of available media files to be played (i.e., a playlist) as well as media player application components 220 (i.e., modules) to be executed or displayed for each media item of the playlist. The presentation data file may further define the modules 220 by defining the ordering and timing of the modules 220 for a given media file (i.e., when a module is active and inactive). The timing of the modules 220 may be expressed as a function of time, events, or elapsed frames of the media file with which the module is associated. For modules 220 relating to the presentation of the media file to a user, the presentation data file also may specify the location and placement of the module within the media player application. The presentation data file may be a XML-based file such as a Media RSS (MRSS) file. Alternatively, the presentation data file may be a binary file. As a binary file may have a smaller file size than other file formats, the length of time to download a binary presentation data file may decrease, thereby improving performance of the system. A sample presentation data file is shown below:

<rss version=“2.0” xmlns:media=http://search.yahoo.com/mrss

xmlns:yemp=“http://schemas.yahoo.com/yemp/”>

<channel>

<!-- Modules that are used for all items -->
<yemp:module start=“0”

source=“http://server.yahoo.com/yemp/modules/PlayerControls.swf”

zIndex=“9000” />

<item>

<yemp:module start=“before”

source=“http://server.yahoo.com/yemp/modules/StartFrame.swf”

parameters=“src=http://server.yahoo.com/yemp/temp/SampleThumbnail
.jpg”

zIndex=“9000” />

<media:content

url=“http://server.corp.yahoo.com/yemp/temp/test.flv”
type=“video/x-flv”>
<media:title>A ye olde TV Tuning</media:title>
<media:description>TV tuning video

clip</media:description>

<media:thumbnail

url=“http://i.imdb.com/Photos/Mptv/1388/th-

5746_0077.jpg”

height=“50” width=“75” />

</media:content>
<yemp:module start=“after”

source=“http://server.yahoo.com/yemp/modules/PostRoll.swf”

</item>

</channel>
</rss>

The presentation data file may enable presentation aspects and application logic to be dynamically changed for a media file. For instance, the above sample presentation data file includes a player controls module, a start frame module, and a post-roll module. However, different modules may be substituted on-the-fly by modifying the presentation data file to call other modules. The placement or timing of the modules may be dynamically modified by changing the specifications for the various modules listed in the presentation data file, such as the “height,” “width,” and “module start” parameters.

The client device may execute a standalone media player application 240 or instantiate a media player application 240, within, for instance, an Internet browser. In one embodiment, the media player application 240 may be a Flash-based application. In one embodiment, the media player application 240 may be created as a Microsoft Silverlight™ application capable of playing WMV and WMA media files. The media player application 240 may serve as a platform for the extensible media player, and may include an Application Programming Interface (API) 245 which communicates with the various modules. In this respect, the API 245 may enable the modules 220 to interface with the player application 240 and control the presentation and playback aspects of the player application 240. In one embodiment, the player application API 245 may be public, thereby enabling distributed development of modules.

The presentation data file may be passed to the media player application from within a web page as a parameter or programmatically via JavaScript if the media player application is embedded on a web page. Alternatively, the presentation data file may be retrieved from the network by the media player application if the media player application is given or has knowledge of the source address of the presentation data file. A presentation data file parser 250 may parse the presentation data file 230 to reveal a playlist of media files available for playback. In one embodiment, the presentation data file parser 250 may be integrated into the media player application 240. In one embodiment, the playlist may list a set of FLV videos. An instance of the playlist may be passed to the instantiated or executed media player application, which may further parse the playlist to identify playlist items corresponding to available media files. Each playlist item may have a presentation instance that identifies the modules associated with the playlist item. The playlist items on the playlist may each include an address or link to the location where a corresponding media file 215 is stored. In response to the selection of a playlist item from the playlist, the player application 240 may transmit a request to the server 205 to download or stream the selected media file 215. While the embodiment discussed herein may identify a single server storing media files and modules, it is contemplated that multiple servers may be employed to store modules, media files, and, if the application is instantiated on a client device, an application SWF file. The present invention is not intended to be limited with respect to the number of servers employed, and it is conceivable that each component or aspect of the extensible media player may originate from or be located in a different location. Modules 220 associated with the selected media file also may be downloaded. In one embodiment, the modules 220 may be downloaded separately. Alternatively, the modules 220 may be packaged as one file at the server and downloaded to the client, thereby minimizing network traffic. Packaging the modules as one file may also reduce the load time of the modules, thereby improving the user viewing experience. The media player application 240 may load the selected media file 215 and the downloaded modules 245 for playback and presentation to the user.

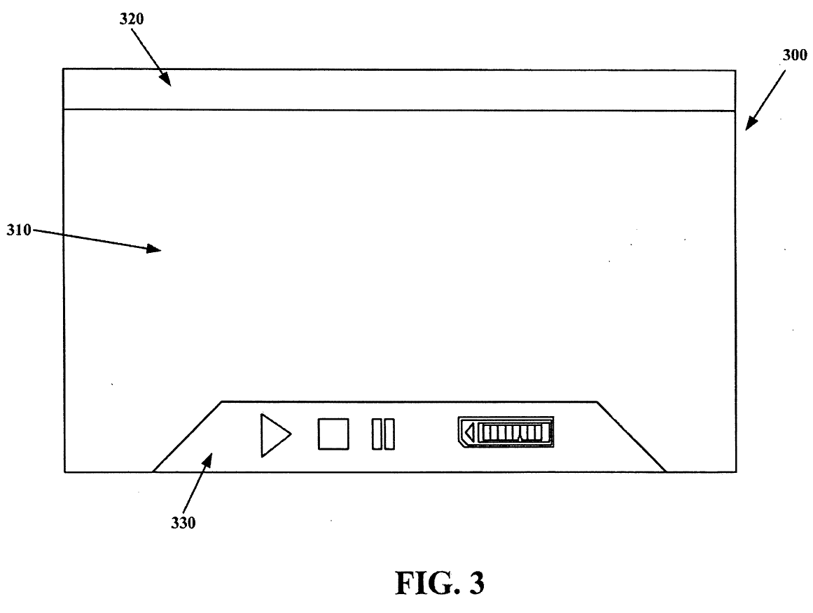

FIG. 3 illustrates an embodiment of an extensible media player. The media player application 300 may be instantiated in a client device, in, for instance, an Internet browser, or may function as a standalone media player application. The media player application 300 may be a Flash-based application. The media player application 300 may include a viewing screen 310 for displaying a selected media file. One or more modules associated with the selected media file may be downloaded and displayed prior to, concurrently with, or subsequent to the playing of the media file. In this embodiment, a banner module 320 may obscure the top portion of the video screen 310. The banner module 320 may display a banner advertisement concurrent to the playing of the selected media file. The placement and shape of the banner module 320 are not fixed; the banner module 320 may be placed anywhere in the video screen 310. In this embodiment, a player controls module 330 may transparently overlay the video screen 310 at the bottom of the video screen 310. The player controls module 330 may permit a user to control the playing of the selected media file. In this embodiment, the player controls module 330 may include a play button, a stop button, a pause button, and a volume adjustment control, but the player controls module 330 need not be limited to these controls and may include additional user controls.

In the event one or more of the modules fail to download or load properly, the instantiated or executed media player application 300 may nevertheless continue to operate without the failed module(s). As the modules provide additional functionality or presentation to the media player application, at a basic minimum, the extensible media player 300 may play the selected media file absent any of the modules, should the modules fail to download or load properly.

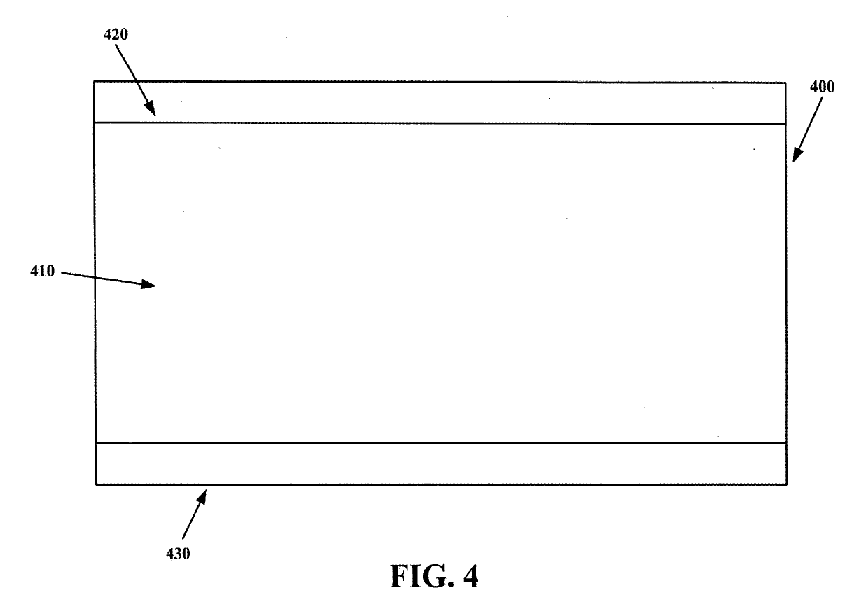

FIG. 4 illustrates an embodiment of an extensible media player. In this embodiment, a media player application 400, either instantiated or executed, may have loaded a selected media file and associated modules. One of the associated modules may be a pre-roll curtain module. The pre-roll curtain module may display an advertisement or other content prior to the playing of the selected media file. In this embodiment, an advertisement may be displayed in the video viewing screen 410. The pre-roll curtain module may include one or more banners 420, 430 which specify identifying information, such as the source of the advertisement displayed and the provider of the media file to be played. The duration of the pre-roll curtain module may be defined by the presentation data file. This duration is dynamic and may differ depending on, among other things, the media file presented or requirements specified by the advertiser.

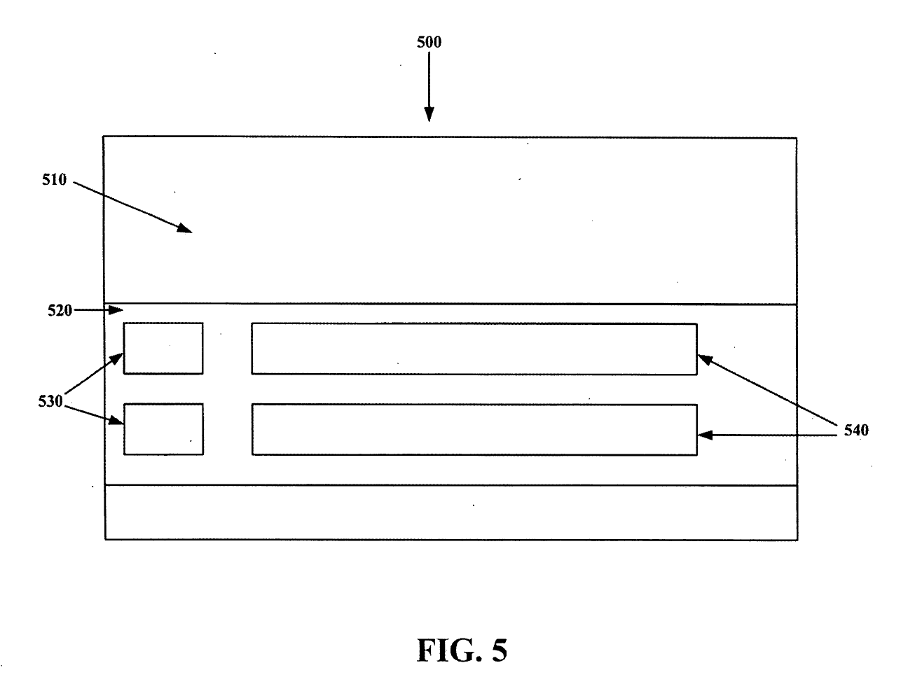

FIG. 5 illustrates an embodiment of an extensible media player. In this embodiment, a media player application 500, either instantiated or executed, and housed in a client device may load and play a selected media file in a video viewing screen 510. Accompanying the loading and playing of the selected media file may be selected modules, downloaded from a server and defined by a presentation data file transmitted from the server to the client device. One of the modules may be a clip list module 520 listing additional media files available for playback. The clip list module 520 may either transparently overlay or fully obscure part or all of the video viewing screen 510. The clip list module 520 may be interactive with the user, enabling the user to select a displayed clip for playback. In one embodiment, the clip list module may be displayed subsequent to the playing of a selected media file. Generally, the timing of execution of the clip list module 520 and other modules is defined in the presentation data file which is parsed and passed to the media player application 500. The clip list module may include one or more thumbnail preview images 530 and accompanying captions 540 describing the subject matter of the media files.

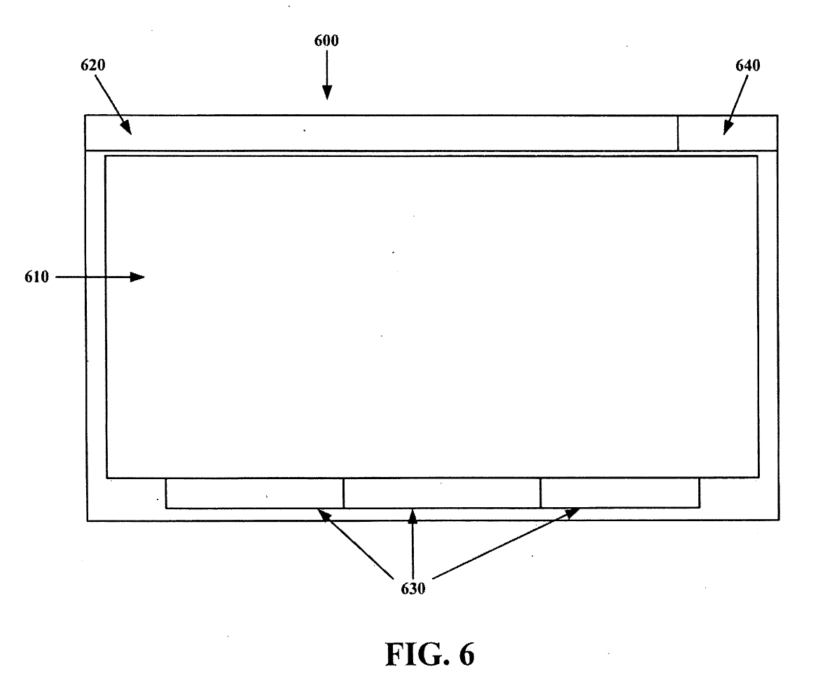

FIG. 6 illustrates an embodiment of an extensible media player. The extensible media player application may be configured to display rich media advertisements, which display an advertisement to a user and enable the user to interact with the advertisement. A rich media advertisement may be displayed any time prior to, concurrent with, or subsequent to the playing of a selected media file. The advertisement may be displayed when a video is paused or otherwise halted. The timing of the rich media advertisement may be defined by the presentation data file passed from the server to the client. In this embodiment, the rich media advertisement may include an advertisement displayed in a video viewing screen 610, accompanied by a banner 620 identifying the source of the advertisement, interactive banners 630 enabling a user to obtain additional information about the advertisement, and an exit button 640 enabling a user to close or exit from the advertisement. The duration and placement of these presentation aspects is not fixed and may be specified in the data presentation file. The interactive banners 630 may be configured to communicate with remote sources for retrieval of additional information related to the advertisement. In response to the selection of one of the interactive banners 630, the banners 630 may open additional browser windows and/or direct the user to a related content.

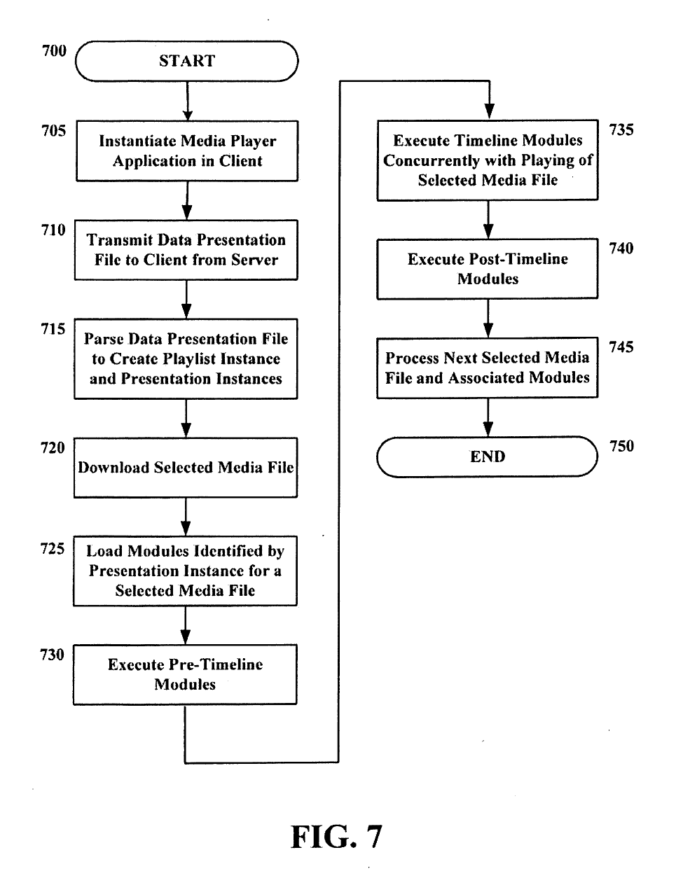

FIG. 7 is a flowchart illustrating one embodiment of a method for providing an extensible media player. In block 705, a media player application may be instantiated in a client device. In one embodiment, the media player application may be a Flash application embedded in a web page in an Internet browser. Alternatively, the media player application may be created as a Microsoft Silverlight™ application. In block 710, a presentation data file may be transmitted to the client device from the server. The presentation data file may be passed to the media player application from within a web page as a parameter or programmatically via JavaScript if the media player application is embedded in the web page. Alternatively, the media player application instantiated or residing in the client device may be given the source address of the presentation data file in order to fetch the presentation data file from a remote source in a network. The presentation data file may define a set of media files available for playback. Additionally, the presentation data file may specify one or more modules associated with each of the defined media files. These modules may affect an aspect of the presentation of a media file to a user or may extend the functionality of the media player application. The modules may control the presentation, playback, and other aspects of the media player through interaction with an API of the media player application. The presentation data file may specify presentation parameters for the modules affecting presentation aspects of the media file, such as, for example, the height, width, aspect ratio, transparency, and duration of the modules for a particular media file.

In block 715, the presentation data file may be parsed, and an instance of a playlist document may be passed to the media player application. The playlist instance may include a playlist items corresponding to media files available for playback. Each playlist item listed in the playlist may include an address or location from which a corresponding media file may be retrieved. A presentation instance may be created for playlist item listed in the playlist instance. The presentation instance may specify which modules and module-specific parameters are to be used by the media player application for a specific media file. In block 720, in response to a user selection of a playlist item, the media player application may request that a server transmit the requested media file corresponding to the playlist item to the client device. The server may transfer or stream the requested media file. In block 725, the media player application may load the downloaded or streamed media file and specified modules associated with the selected media file. The modules may be downloaded from URLs specified in the presentation data file. Version checking for each module may be performed using the module URL.

In block 730, pre-timeline modules, defined to be executed and/or displayed prior to the playing of the selected media file, may be executed. Examples of pre-timeline modules may include but are not limited to a pre-roll curtain displaying an advertisement, and a container module to house third party content which may conflict or be non-conforming with the media player application. In block 735, the media player application may load and play the selected media file. The media player application also may execute and/or display modules chosen to concurrently run with the playing of the media file. Such modules may include but are not limited to a banner module to display an advertisement during playing of the media file, a player controls module to display a set of user controls for controlling the playing of the media file, a closed captioning module to display closed captioning, and a clip list module to offer additional available media files for playback. In block 740, subsequent to the playing of the media file, the media player application may execute and/or display post-timeline modules. Post-timeline modules may include but are not limited to the clip list module and a post-roll curtain module to display an advertisement subsequent to the playing of the media file. In block 745, the media player application may process the next playlist item selected by a user. Processing may include downloading or streaming the media file, downloading associated modules, and loading the media file for the next playlist item and associated modules.

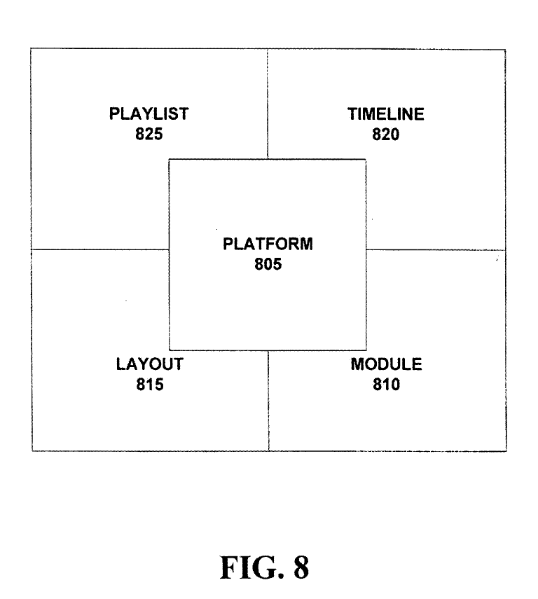

FIG. 8 illustrates an embodiment of a software platform supporting an extensible media player. While the software platform 805 may reside in and otherwise be supported by the system of FIG. 1, various system architectures and configurations may be employed. The platform 805 generally supports the embodiments disclosed herein. The platform 805 may support the use of various independent and decoupled modules 810 and layouts 815 to deliver an extensible media player. These modules 810 and layouts 815 may be programmatically delivered to the media player or via a data file. A sample high-level outline of a data file is shown below:

<?xml version=“1.0” encoding=“UTF-8”?>
<MTL xmlns=“http://video.yahoo.com/YEP/1.0/”>

<Playlist>

<Layouts/>
<Modules/>
<TimelineTemplates/>
<Timelines/>

</Playlist>
<Data/>

</MTL>

The data file may describe and configure a media player application. The data file is structured in a hierarchical format, such that the data file may describe a playlist of timelines and associated media files or applications, and within the playlist, one or more layouts, modules, timelines, and timeline templates that are associated with one or more media files in the playlist. The modules 810 may interface with layouts 815, timelines 820, playlists 825, and the extensible media player platform generally via one or more APIs. In this respect, the platform offers to media player and module developers a standard base upon which to consistently process and interact with code or programs written for the extensible media player.

Each module 810 operates to extend a functionality or presentation aspect of the media player or to enhance the media player experience, such as through user interactivity. Each module may be decoupled from other modules such that each module operates independently of other modules. Because each module operates independently of other modules, a developer may create his or her own modules that may be injected or loaded into the platform to operate with the media player. However, even though modules are decoupled from each other, the modules may communicate and transfer data between and among themselves. A sample portion of a presentation data file with respect to modules is shown below:

<Modules>
<Module id=“jsapi” source=“http://yepstuff.com/JavascriptAPI.swf”
layoutTargetId=“_none”>

<Parameters>
<Parameter id=“event_function”>y_up_eventHandler</Parameter>
</Parameters>

</Module>
<Module id=“video” source=“http://yepstuff.com/VideoPlayback.swf”
layoutTargetId=“video” isTimeSource=“true”/>
</Modules>

The modules associated with a particular media file also may be selected programmatically via the platform. Modules may run on an application level, a playlist level, or a timeline level. If a module is running on an application level, the module may always be active, and does not need to be defined for each timeline (corresponding to a media file or application) or playlist (corresponding to multiple media files or applications). If a module is running on a playlist level, the module will be active for each timeline located in the playlist. If a module is running on a timeline level, the module is running only when it is activated during the course of a specific timeline and associated media file or application.

A container-based layout approach may be used to organize the location of modules and media files within the media player application. Using this approach, one or more modules 810 may be placed within a layout container by the platform, with multiple containers capable of being used together to control the display of various modules when the media player is executed. Modules may be placed within a particular layout container by specifying a layout ID corresponding to the layout container in which the module is to be inserted. Use of containers to define the location of modules may eliminate the need to place modules directly on the display, and consequently logic or code previously used to define the size and placement of the modules on the display is unnecessary.

One supported module is a playback controls module that governs the execution or playback of media files in the player application. The playback controls module may include functionality for displaying the duration of a media file and controlling the play back of a media file, such as media player controls for playing, pausing, or stopping a media file, adjusting the volume of a media file and so forth. The playback controls module may provide additional functionality for interacting with a user if an application, such as a game, is presented to the user in place of a media file. For an application, the playback controls module may specify a duration in relation to some aspect of the application. For instance, if the application is a game, a game module may give a user 10 seconds to respond to a question. The playback controls module may display this 10 second duration to the user. A playlist 825 may store or maintain a list of timelines to be played. As described in more detail below, each timeline may specify a set of modules and timing information, such as activation points (e.g., start and stop points), for each of the modules associated with the timeline. The modules associated with the timeline may playback one or more files of a media type (e.g., a multimedia file, an audio file) or may run one or more applications, such as a game. These media files and applications may be played back or executed at the same time if desired. The media file(s) or application(s) to be rendered may be determined by the modules associated with the timeline. The playlist 825 may maintain templates or common elements for one or more timelines. If a presentation data file is used to specify timelines to be loaded and modules and layouts to accompany the timeline to render media files or applications, the presentation data file may reference or call templates to be loaded for the media files or applications. The templates or common elements may define which modules 810 are to be used during the playback of the timelines and media files, with the advantage being that modules 810 commonly used by one or more media file may be retrieved once and reused, thereby eliminating a need to call and retrieve the modules from the servers for each media file. Additionally, templates may eliminate the need to redefine common elements multiple times, in the presentation date file for example, thereby improving the speed at which the modules load and allowing modifications to be made easier. If templates are not used, the playlist 825 may store a list of timelines to be played, along with associated modules 810 and layouts 815 to be retrieved and used in the presentation and play back of each timeline.

In one embodiment, instead of using pre-roll, concurrent, and post-roll modules (relative to the playback of a timeline) to control the timing of activation or execution of modules, a module 810 may serve as a time source, or a timing reference to synchronize the activation or execution of other modules relative to the playback of the timeline and the media file. The timeline 820 may start playing modules and may activate and playback a media file or execute an application. As contemplated herein, a timeline may be a combination of modules, UI and data that is used to display one or more clips of media or one or more applications. The modules may execute or otherwise remain active for the duration of the timeline. Because the module 810 serves as a timing reference, other modules may be activated or called using the timing parameters maintained by the module 810. The timing references provided by the module 810 may be expressed in, for example, seconds elapsed or remaining, frames elapsed or remaining, percentage of media file played back or completed, percentage of the media file remaining, or any other way by which a media file or application may be measured. Sample code from a sample presentation data file with respect to the timeline is shown below:

<Timelines>

<Timeline id=“timeline1” templateId=“defaultTimeline”/>
<Timeline id=“timeline2” templateId=“defaultTimeline”>

<!-- Layouts specific to timeline2 -->
<!-- Metadata specific to/overridden by timeline2 -->
<!-- Parameters specific to/overridden by timeline2 -->
<!-- Modules specific to timeline2 -->

</Timeline>

</Timelines>

The platform 805 and the modules 810 may support the use of blocking modules that prevent or halt the execution or playback of the timeline until some predetermined event occurs. A blocking module also may pause a timeline. Any other module 810 may act as a blocking module through the assertion of a blocking flag or other indicator that identifies to the time source module 810 and the platform 805 that the execution of the timeline is to be stopped until the blocking module gives permission for execution or playback to be resumed. Permission may be given by activating or otherwise interacting with the functionality of the blocking module causing execution of the timeline to be blocked.

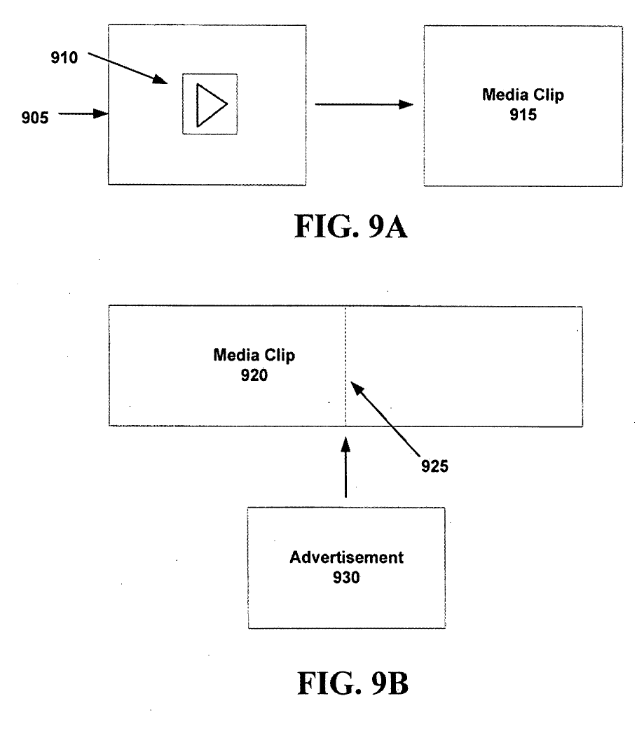

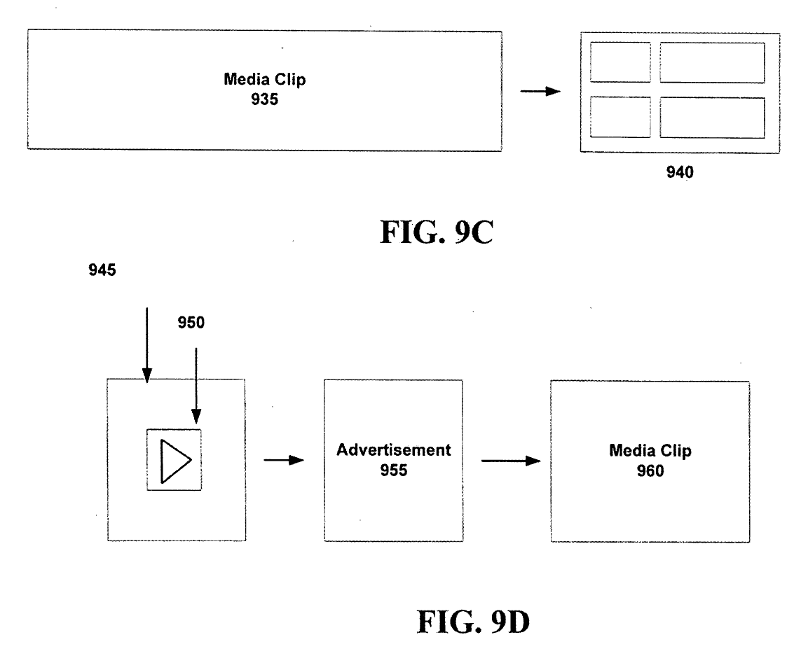

FIGS. 9A through 9D illustrate exemplary embodiments involving the use of a blocking module. In FIG. 9A, an embodiment of a commonly occurring blocking scenario is illustrated. When a timeline and one or more modules are first loaded into the media player application for playback, media files or applications dynamically or programmatically associated with the timeline and modules (via the presentation data file, for instance) may be retrieved from the central server and/or loaded. A timeline (and the playback of modules and associated media files or applications) may be blocked by a start screen module 905. The start screen module 905 may indicate that playback of the timeline is to be blocked by asserting a blocking flag in the module. The blocking flag will alert the platform that playback of the timeline and associated media file is not to occur until the start screen module gives permission. In this embodiment, the start screen module 905 may require that a user select or trigger a play button or icon 910 located in a separate playback controls module in order to start playback of the timeline and media file. Prior to the play button 910 being selected, the platform will not permit the video to start playing on its own. When a user selects the play button, a signal or other indication may be sent to the media player platform that the play button was selected. The platform may respond to the start screen module 905 to ask if playback of the media file and execution of the timeline may start or otherwise continue. The start screen module 905 may indicate that play may continue (or start). The start screen module 905 may de-assert its blocking flag thereafter to allow the media file 915 to be played.

FIG. 9B illustrates an embodiment involving the use of a blocking module. In this embodiment, a media file 920 may be playing in the media player application. When the timeline, and in this case the media file, reach a certain predetermined timing reference point 925, such as for example, 50% completion of the media file, an advertisement module 930 may activate and block continued playback of the media file until after the advertisement retrieved or called by the advertisement module 930 is completed. In other embodiments, the predetermined timing reference point may be based on the timeline alone, the duration of a particular module, or the media file or application associated with the timeline, For example, if a timeline is associated with multiple media files, a timing reference point may be set for 25% of the timeline irrespective of the duration or playback status of the associated media files. The presentation data file may reference the advertisement module 930 with a timeline or a playlist, such that the advertisement module 930 is retrieved with other modules when the timeline is loaded into the media player application. Activation of the advertisement module may pause the media file. The platform may ask or query the advertisement module 930 as to when playback of the timeline and media file may resume. When the ad finishes execution or displaying, the advertisement module 930 may deassert its blocking flag and respond to the platform that playback may resume.

FIG. 9C illustrates an embodiment involving the use of a blocking module. In this embodiment, a timeline and associated module, layouts and a media file 935 may be loaded into a media player application. The timeline and media file 935 may play for their duration, at which point a selection module or module that lists additional media files may activate and display additional media files that may be selected and played. The selection module 940 may block the media player application from executing until one of the media file options listed on the selection module 940 or the media file list is chosen. Alternatively, the media player application may unblock and resume operation if a predefined timeout period occurs. In this case, the next media clip may be selected and played by the media player.

FIG. 9D illustrates an embodiment in which successive blocking modules may activate. A timeline and its associated modules and a media file 955 may be loaded at time t=0 relative to the duration of the media file. The time may be maintained by the media file itself or by a timesource module. A start screen module 945 may assert its blocking flag to the platform to prevent the media file from executing until a play or start button is selected. The platform may ask the start screen module 945 whether execution may continue. Once a play button 950 has been pressed or selected, the start screen module 945 may respond to the platform that execution of the timeline and media file can continue. The start screen module 945 also may deactivate its blocking flag. A presentation data file that specifies which modules, and their associated media files, are to be loaded for a media file and the order of execution of the module may next specify that an advertisement module 955 is to activate and block playback of the timeline and media file at time t=1. Alternatively, the modules to be loaded and activated may be specified programmatically without recourse to a presentation data file. At time t=1, the advertisement module 955 may activate and block playback of the timeline and media file until the ad is finished displaying. The advertisement module 955 may de-assert its blocking flag and indicate to the platform that playback of the timeline and media file may continue. The media file 960 may then play, and the platform may verify whether additional blocking modules are to be activated during the playback of the media file.

The media files or applications associated with the modules may further include code that handles scenarios involving seeking of a media file. For instance, if a timeline and associated media file are being played, and a user chooses to fast forward or seek ahead to a different part of the media file, the timeline and media file may run into or cross paths with a blocking module that is set to activate prior to the seek ahead location. In this case, the blocking module may or may not permit seeking, such that if the blocking module does not permit seeking ahead, the blocking module will activate and halt the seek at the moment when the blocking module is set to activate. The user is then required to experience or interact with the presentation of the blocking module's content before being permitted to seek ahead. While the blocking module blocks the media file from seeking ahead, the blocking module or the platform may track and remember the desired seek ahead location, such that when the blocking module de-asserts its blocking flag, the timeline and media file are transported ahead to the desired seek ahead location. Similar functionality may be effected for scenarios where a user desires to seek backwards in a timeline and associated media file. For those situations where a user has already viewed or otherwise executed a blocking module, the blocking module may include code that may prevent a blocking module from re-activating or triggering if a user seeks backwards and crosses paths with the blocking module again. Alternatively, there may be instances in which a blocking module will always activate regardless of whether a seek forward or backward triggers the blocking module.

In one embodiment, a timeline may be synchronized to a specific module rather than a central clock maintained by the media player platform. In this case, a module may be activated at a reference point of another module. In one embodiment, a specific module may act as a timing reference if the parameter “timesource=true” is set.

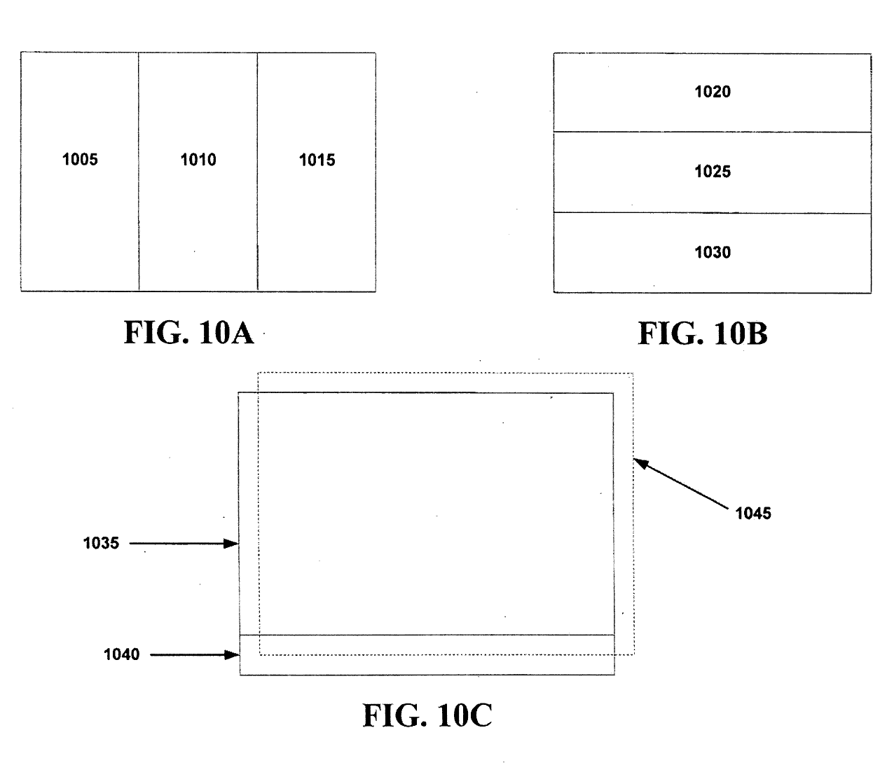

FIGS. 10A through 10C illustrate embodiments of layout containers. The layout of a media player application defines the visual structure of the display using containers. A layout container is a layout object that can contain other containers or modules. Layout containers are used to organize modules on the display. Multiple layout containers may be used together to display modules. Each layout container may have an associated layout container ID. Modules can be placed in a certain layout container by specifying a container ID. This specification can exist in a presentation data file or can be made programmatically. Default layouts can be defined on the application or playlist level for all timelines and modules, but individual timelines with different layouts can override a default layout. Similar to previously described with respect to modules, layouts may operate on an application level, a playlist level, or a timeline level. If a layout operates on an application level, the layout may always be active, and does not need to be defined for each timeline (corresponding to one or more media files or applications) or playlist (corresponding to multiple timelines and associated media files or applications). If a layout operates on a playlist level, the layout will be active for each timeline located in the playlist. If a layout operates on a timeline level, the layout operates only when it is activated during the course of a specific timeline and associated media file or application.

Three layout containers may be used to define the visual structure of the display. A Hbox layout container may stack items and modules 1005, 1010, 1015 next to each other horizontally (e.g., in the x-axis). The items and modules in two Hbox containers located adjacently may overlap. A Vbox layout container may stack items 1020, 1025, 1030 on top of each other vertically (e.g., in the y-axis). Vbox layout containers may overlap. Alternatively, a Hbox, Vbox, or any other layout container may clip or mask any children (e.g., modules) that attempt to render outside the container. To render outside a container, a module may request that it be pulled out of the container temporarily if the module is to be on top of or overlap other elements. A Canvas layout container may permit modules or items 1035, 1040, 1045 to overlap each other in a z-axis. Canvas containers may permit layering of modules and other items, or the superimposing of one module over another on the display. In FIG. 10C, a video display 1035 and playback controls 1040 may reside in a first layer with an advertisement 1045 overlaying the display and playback controls. The dimensions of each layout contained may be specified, including height, width, a z-axis index, percent height, percent width, padding or borders, a stretch factor, and a background color. Sample code from a sample presentation data file with respect to layouts is shown below:

<Layouts>

<Layout id=″default″>

<!-- Layout containers -->

</Layout>
<Layout id=“fullscreen“/>

</Layouts>

Layout containers may be used in conjunction with a timeline and associated modules to switch between different layouts and modules during the playback of a timeline and associated media file. For instance, a media player display screen may occupy the majority of a screen with a playback controls module placed in a layout container for display with the display screen. The act of a play button being selected may trigger a transition from one layout to another, with the platform laying out the new layout. Generally, any event may trigger a new layout to be displayed, along with new modules being activated. Additional exemplary embodiments that may trigger new layouts may include the resizing of a video window and clicking an info button that triggers a layout change and activation of an information module.

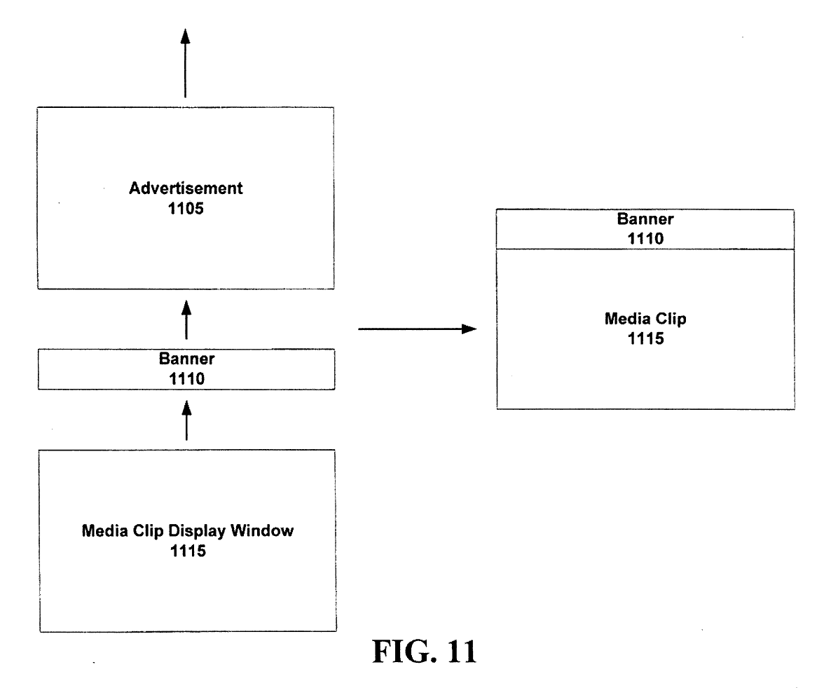

The extensible media player platform may support custom panels. A custom panel may be appropriate where a custom multimedia presentation or additional presentation aspects or features beyond playback of a media file are desired. A custom panel can have a standard layout, such as a video display portion and a set of playback controls. However, a custom panel may enable transitions and animations between layouts. For instance, FIG. 11 illustrates a series of transitions between layouts for a custom panel. An advertisement 1105 contained in a layout container may be displayed prior to the playing of a media file. As the advertisement 1105 finishes playing, the advertisement 1105 may visually slide up the display and out of view. As the advertisement 1105 slides upward, a media file display screen 1115 with a banner advertisement 1110 may slide up to replace the ad 1105 on the display. The media file display screen 1115 and the banner advertisement 1110 may be two separate layout containers. The three layout containers in this embodiment may be placed into the custom panel. Custom logic may be used in the custom panel to animate the transitions between layouts and presentations. Custom logic further may layout the children that are specified for the custom panel.

The extensible media player platform may support timing references, or time sources, beyond the timeline previously disclosed herein. A central clock may be maintained, by the timeline module, the platform, or one of the servers supporting the platform, and one or more media files or modules may serve as time sources. In one embodiment, only one media file or module may be a time source at one time. However, the extensible media player platform may support switching between time sources. By allowing media files to act as time sources, modules, layouts, and other items may synchronize their actions and functionality directly to the media file, rather than relying on a timeline to provide a timing reference.

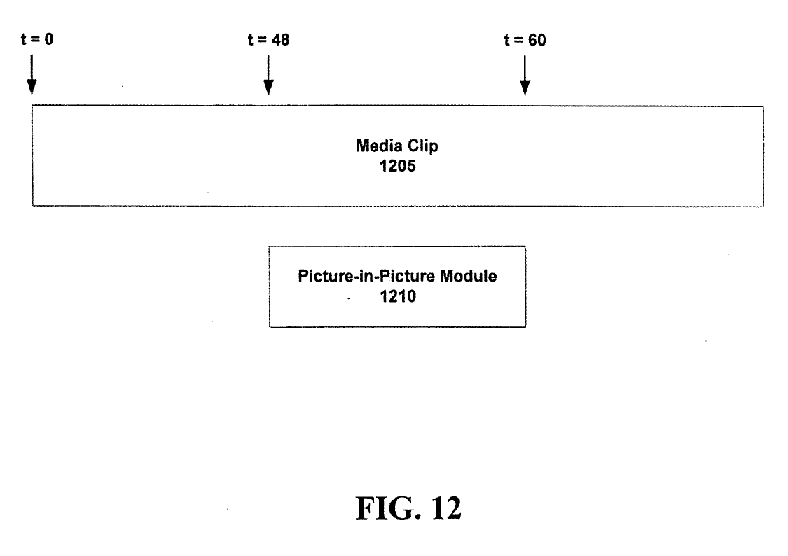

FIG. 12 illustrates an embodiment of a time source. In FIG. 12, a module playing the media clip 1205 acts as a time source and synchronizes to the media file being played when the media file exposes its current position. In this embodiment, a picture-in-picture (PiP) module may be scheduled to activate after 48 seconds of the media file have elapsed. If the transmission rate of the media file slows down or the media file begins to buffer, the PiP module will wait as well, as the PiP is synchronized to the timeline which in turn is synchronized to media clip module 1205. If a timeline served as the timing reference, then the PiP module might activate after 48 seconds have elapsed from the start of the media file, even if the media file began to buffer and did not actually play 48 seconds of content. In this embodiment, the PiP module may remain activated for 12 seconds, or until 60 seconds of the media file have elapsed, at which point the PiP module may deactivate and stop executing.

Additional aspects of the extensible media player platform may support the use of a data store for modules. The data store is a centralized repository from which modules can read and share data. Data contained in a presentation data file may be placed in the data source for retrieval and use. The presentation data file may reference the data store as the location from which to retrieve certain data such that the modules defined in the presentation data file and associated with various media files may understand to retrieve that data from the data store.

Additional aspects of the extensible media player platform may support a transfer manager for prioritizing data downloads among multiple modules. The platform may provide a unified model for retrieving data from the network. The platform may support multiple modules that interact with the platform via one or more APIs. This interaction may include retrieval and downloading of data from one or more servers supporting the platform. A transfer manager is employed as an interface in the platform to handle data transfers. The transfer manager may manage all scheduled transfers to and from modules and may support priority-based queues. The transfer manager may throttle the amount of concurrent network calls made at a time by the modules and other components of the platform and may queue all requests based on a requested priority. The transfer manager may recognize that certain items or data that must be available for playback of a timeline and associated media file to start should have a higher priority than items that can be filled dynamically later, such as additional metadata or information.

The platform may support the notion of callbacks as well. As a transfer request may be specified in terms of data to be downloaded from a URL or other resource locator address, if callback functionality is enabled, the requested data may be loaded from URL-cached content, memory, or an already-loaded module. Any asset may be retrieved using the callback functionality, including modules, layouts, multimedia files, and applications. A separate callback module may handle the callback functionality in order to optimize the number of network calls made by modules. Alternatively, the transfer manager may handle callbacks. Callbacks enable resource transfer requests made by the platform and modules to be fulfilled locally if possible before making a network call for retrieval of such resources.

The platform may support the use of predetermined packages of modules. Use of a package of modules simplifies the calling of modules as modules are bundled together into a file such that only one file needs to be called and retrieved rather than individual modules. The package or any of its modules may be located using a URL as the source ID for the package such that when the package is called by either the dynamically passed or loaded presentation data file or programmatically, the package can be retrieved from the address specified by the URL. The platform further supports the use of callbacks with module packages. If callbacks are enabled for module packages, any time a particular module or a version of the module is desired, the source ID of the package containing the module may be used to register a callback with the particular module or package. If a particular version of the module is desired, a version number may be included in the URL specified as the source ID. Use of the callback for a particular module or version of a module may avoid the need to download the module from the network. If the media player has already loaded a package, and a newer version of a module contained in the package is desired, the URL in the presentation data file can be changed to point to the new version of the module. The media player may start using the newer version of the module, even though the older version of the module is already loaded. Newer module versions may thus be deployed without having to necessarily update the deployed player package immediately.

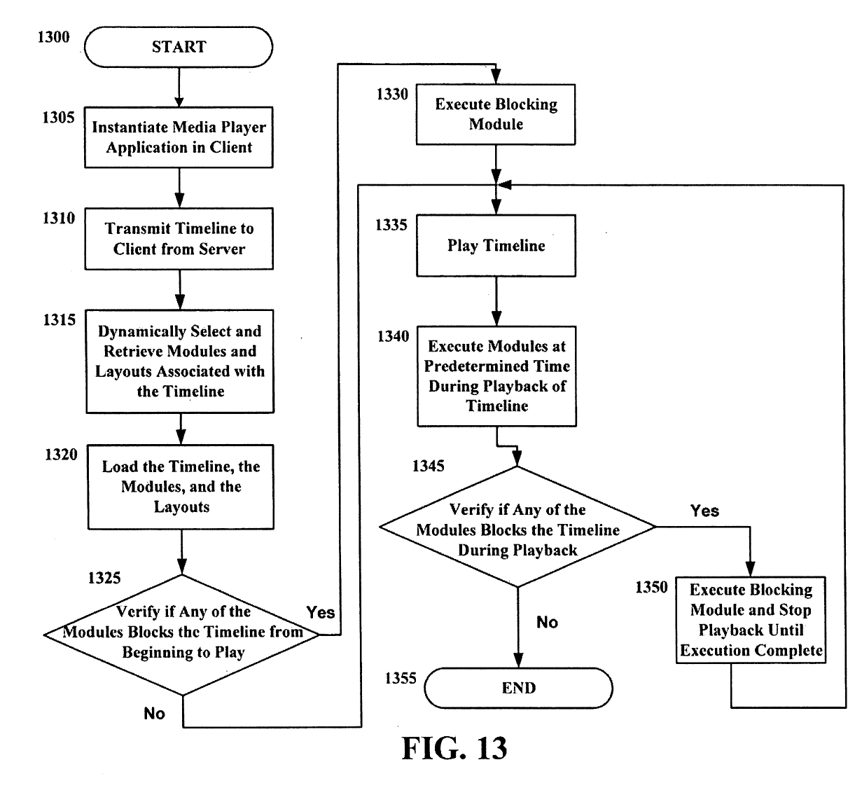

FIG. 13 is a flowchart illustrating one embodiment of a method for providing an extensible media player. In block 1305, a media player application may be instantiated in a client device or system. The media player application is capable of loading and playing a timeline and an associated multimedia file, such as a video clip or audio file, or application, such as a game. In block 1310, a timeline may be transmitted to the client from a server. The timeline may be selected programmatically or through a presentation data file that is sent itself from the server to the client. In one embodiment, the presentation data file may identify multiple timelines and associated multimedia files to be played via a playlist. In block 1315, modules and layouts associated with the timeline may be dynamically selected and retrieved from the server. The modules and layouts may be identified in the presentation data file, or may be passed to the client from the server. Modules may extend the functionality of the media player application, while layouts may define the presentation, such as the placement and sizing, of the modules on a display. In block 1320, the modules, layouts, and associated multimedia file may be loaded into the media player application. In block 1325, prior to playback of the timeline but subsequent to loading of the timeline, the modules, and the layouts, the media player application may verify whether any of the loaded modules are blocking modules that prevent the timeline from initiating playback. A module may indicate that it is a blocking module through the assertion of a blocking flag or other indicator recognizable to the media player application or platform.

If one of the loaded modules has asserted a blocking indicator, the media player application may execute the blocking module first, as shown in block 1330. An example of a blocking module that may prevent a timeline from beginning playback may be a start screen module that requires a user to select a play button associated with a playback controls module to initiate playback. In this respect, the timeline will not begin playing automatically after being loaded. Another example of a blocking module that may prevent a timeline from beginning playback may be an advertisement that is shown before the timeline begins playing. If no module blocks the initial playback of the timeline, the timeline may begin playing, as shown in block 1335. As the timeline plays, one or more modules may execute at predetermined times relative to the timeline playback, as shown in block 1340. The predetermined times may be determined by a module that maintains a timing reference relative to the playback of an associated multimedia file or by a central clock or timing reference maintained by the media player platform. Alternatively, the predetermined times may be determined relative to the multimedia file itself, in that the modules may synchronize to the multimedia file itself if the file is a timesource, as previously described herein. In block 1345, as each module executes during playback of the timeline, the media player application or the platform may verify whether any of the executing modules act as blocking modules. If so, playback of the timeline is stopped, and the blocking module may complete execution before playback resumes, as shown in block 1350. An example of a blocking module that may stop playback of the timeline is an advertisement or commercial. A user clicking on a banner advertisement or other interactive feature associated with the timeline being played also may stop playback as the user is directed to additional content or advertisements. If no blocking modules are executed during playback of the timeline, the timeline may play until it reaches its end. The method ends at block 1355.

Those of skill in the art will appreciate that an extensible media player may be enabled to facilitate the deployment of a multi-layered dynamic media player system. Such a system may be implemented and deployed without the delay of a traditional product cycle. The dynamic nature of the extensible media player allows for the media player application to be modified based on changing business needs and on a per view or per user basis. The present disclosure is not intended to be limited with respect to the type of device capable of implementing the extensible media player. Moreover, the present disclosure is not intended to be limited with respect to the modules and layouts disclosed herein. Additional modules and layouts may be employed to add functionality to the media player application or to control an aspect of the presentation of a media file played in the media player application.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. An extensible media player, comprising:
a media player application to load and play at least one multimedia file or load and execute at least one application;
a plurality of modules, each module containing application logic to extend functionality of said media player application; and
a plurality of layouts, each layout containing logic to control an aspect of a presentation of said media player application and said plurality of modules;
wherein said media player application loads and plays a timeline, at least one module associated with the timeline, and a multimedia file or application associated with the timeline, and
wherein at least one module and at least one layout are dynamically associated with the timeline,
wherein the each of the at least one module associated with the selected timeline is executed at a predetermined time using a timing reference, and wherein each of the at least one module is capable of blocking the timeline from progressing.

2. The extensible media player of claim 1, wherein select ones of the at least one module are assigned to the at least one layout associated with the timeline.

3. The extensible media player of claim 1, wherein if the blocking indicator is asserted, the each of the at least one module de-asserts the blocking indicator after execution of the each of the at least one module.

4. The extensible media player of claim 1, further comprising a presentation data file to dynamically associate the at least one module and the at least one layout with the timeline, wherein the media player application parses the presentation data file and loads the at least one module and the at least one layout for the timeline based on the parsing.

5. The extensible media player of claim 1, wherein the at least one module is bundled into a package, the package enabling a single download from a server.

6. The extensible media player of claim 1, wherein the timing reference is expressed as one of time elapsed, time remaining, percentage completed, percentage remaining, number of frames elapsed, and number of frames remaining.

7. The extensible media player of claim 1, wherein said plurality of layouts include layout containers that are empty and layout containers to which the at least one module is assigned.

8. The extensible media player of claim 7, wherein the layout containers include a vertical box layout container to stack the layout containers in a y-direction, a horizontal box layout container to stack the layout containers in a x-direction, a canvas layout container to stack the layout containers in a z-direction, and a custom panel layout container to arrange the layout containers in a custom arrangement and to animate transitions between the layout containers using custom logic.

9. The extensible media player of claim 1, wherein the timing reference is one of the at least one module associated with the timeline.

10. The extensible media player of claim 1, further comprising a transfer manager to process data transfer requests from said plurality of modules.

11. The extensible media player of claim 10, wherein said transfer manager processes the data transfer requests using a priority-based queue.

12. The extensible media player of claim 1, wherein each of said plurality of modules is configured to communicate with each other and a server.

13. The extensible media player of claim 1, wherein if a callback functionality is enabled, the at least one module, the at least one layout, the multimedia file, or the application is retrieved from cached content located using a URL, and wherein if the cached content is not available, the at least one module, the at least one layout, the multimedia file, or the application is retrieved from a server.

14. The extensible media player of claim 1, further comprising a playlist to store a plurality of timelines.

15. The extensible media player of claim 14, wherein said playlist stores a template of retrieved and pre-loaded modules and layouts to be used with one of the plurality of timelines.

16. A method, comprising:
instantiating a multimedia player application on a client system;
transmitting to the client system a timeline to be played by the multimedia player application;
dynamically selecting and retrieving at least one module and at least one layout associated with the timeline, wherein the at least one module contains application logic to extend functionality of the multimedia player application, and wherein the at least one layout controls an aspect of a presentation of the multimedia player application and the at least one module;
loading, in the instantiated multimedia player application, the timeline, the at least one module, and the at least one layout;
verifying whether any of the loaded at least one module is blocking the timeline from beginning to play, wherein if a module of the at least one module is blocking the timeline, executing the blocking module and preventing playback of the timeline from starting until the execution is complete, and wherein if no module is blocking the timeline, beginning playback of the timeline;
executing each module of the at least one module and each layout of the at least one layout at a predetermined time during playback of the timeline; and
during said executing, checking whether the each module is blocking the timeline, wherein if the each module is blocking the timeline, stopping or pausing playback of the timeline until the execution is complete.

17. The method of claim 16, wherein said verifying and said checking comprise reading a blocking indicator associated with the module to determine if the blocking indicator is asserted.

18. The method of claim 16, wherein the transmitted timeline and the dynamically selected at least one module and the at least one layout are identified in a presentation data file, the presentation data file being parsed by the multimedia player application.

19. The method of claim 16, further comprising retrieving a package containing the at least one module from the server.

20. The method of claim 16, wherein the predetermined time is determined by a timing reference relative to the playback of the timeline.

21. The method of claim 20, wherein the predetermined time and the timing reference are expressed as one of time elapsed, time remaining, percentage completed, percentage remaining, number of frames elapsed, and number of frames remaining.

22. The method of claim 16, further comprising assigning the each module of the at least one module to one of the at least one layout.

23. The method of claim 16, further comprising, responsive to said executing,
receiving, at a transfer manager, data transfer requests from the each module; and
processing the data transfer requests from the each module in an order specified by a priority-based queue.

24. The method of claim 16, wherein each of the modules is configured to communicate with other modules and the server.

25. The method of claim 16, wherein said dynamically selecting and retrieving comprises:
retrieving the at least one module, the at least one layout, at least one multimedia file to be played, or at least one application to be executed from cached content located using a URL, if callback functionality is enabled; and
if callback functionality is not enabled or if the cached content is not available, retrieving the at least one module, the at least one layout, the at least one multimedia file to be played, or the at least one application to be executed from a server.

26. The method of claim 16, further comprising storing a plurality of timelines in a playlist.

27. The method of claim 26, further comprising storing a template in the playlist, the template storing retrieved and pre-loaded modules and layouts to be used with one of the plurality of timelines.

28. A computer-readable storage medium storing instructions which, when executed by a processor, perform the method of claim 16.

29. A multimedia presentation system, comprising:
a server, storing timelines, multimedia files, applications, a plurality of modules, and a plurality of layout containers; and
a client, configured to communicate with said server, comprising a processing unit and a memory unit, said memory unit storing instructions adapted to be executed by the processing unit to:
instantiate a multimedia player application on a client system;
transmit to the client system a timeline to be played by the multimedia player application;
dynamically select and retrieve at least one module and at least one layout for the timeline, wherein the at least one module contains application logic to extend functionality of the multimedia player application, and wherein the at least one layout controls an aspect of a presentation of the multimedia player application and the at least one module;
load, in the instantiated multimedia player application, the timeline, the at least one module, and the at least one layout;
verify whether any of the loaded at least one module is blocking the timeline from beginning to play, wherein if a module of the at least one module is blocking the timeline, execute the blocking module and preventing playback of the timeline from starting until the execution is complete, and wherein if no module is blocking the timeline, beginning playback of the timeline;
execute each module of the at least one module and each layout of the at least one layout at a predetermined time during playback of the timeline; and
during said executing, check whether the each module is blocking the timeline, wherein if the each module is blocking the timeline, stopping or pausing playback of the timeline until the execution is complete.

30. The system of claim 29, wherein the set of modules is bundled into a package, the package enabling a single download from the server.

31. The system of claim 29, wherein if a callback functionality is enabled, the at least one module, the at least one layout, at least one multimedia file to be played, or at least one application to be executed is retrieved from cached content located using a URL, and wherein if the cached content is not available, the at least one module, the at least one layout, the at least one multimedia file to be played, or the at least one application to be executed is retrieved from a server.

32. The system of claim 29, wherein said verifying and said checking comprise reading a blocking indicator associated with the module to determine if the blocking indicator is asserted.

33. The system of claim 29, wherein the predetermined time is determined by a timing reference relative to the playback of the timeline, the predetermined time and the timing reference being expressed as one of time elapsed, time remaining, percentage completed, percentage remaining, number of frames elapsed, and number of frames remaining.

34. The system of claim 29, wherein the transmitted timeline and the dynamically selected at least one module and the at least one layout are identified in a presentation data file, the presentation data file being parsed by the multimedia player application.

35. The system of claim 29, wherein each of the modules is configured to communicate with other modules and the server.

36. The system of claim 29, wherein the client further stores a plurality of timelines in a playlist.

37. The system of claim 36, wherein the playlist further stores a template, the template storing retrieved and pre-loaded modules and layouts to be used with one of the plurality of timelines.

38. The system of claim 29, wherein the server receives, at a transfer manager, data transfer requests from the each module; and
processes the data transfer requests from the each module in an order specified by a priority-based queue.
